(19) United States
(12) Patent Application Publication
(10) Pub. No.: US 2013/0034636 A1
(43) Pub. Date: Feb. 7, 2013

(54) CANDY APPARATUS, SYSTEM AND METHOD

(71) Applicants: Andrea Loflin Anaya, Salem, UT (US); Aaron A. Patey, Elk Ridge, UT (US)

(72) Inventors: Andrea Loflin Anaya, Salem, UT (US); Aaron A. Patey, Elk Ridge, UT (US)

(73) Assignee: Charmeur, LLC, Salem, UT (US)

(21) Appl. No.: 13/197,685

(22) Filed: Aug. 3, 2011

(51) Int. Cl. A23G 3/52

(52) U.S. Cl. 426/233; 99/485

(57) ABSTRACT

A system, apparatus and methods for candy making are disclosed, wherein an apparatus for candy making may comprise a blade portion and a handle portion, and wherein the handle portion may be multiple times longer than the blade portion.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND

The disclosure relates generally to candy making devices used during the cooling and set-up of candy. Also disclosed are devices that are used to mix air into a candy body or pool, and more particularly, but not necessarily entirely, to a hand operated candy making device.

Candy making is an age old occupation and various techniques have been used for hundreds of years. Candy can be based on many ingredients, and one such primary ingredient is sugar and its many derivatives, such as corn syrup. These sugar like bases can be cooked into a liquid state and then manipulated into a final product. Often such manipulation involves the introduction of flavors and colors into the mixture. As the candy mixture works its way toward becoming more solid, it can be increasingly difficult to work. Under such circumstances, currently available tools lack the strength to operate effectively. Wood tools can break or leave wood particles in the mixture. All metal tools can, and do, conduct heat away from the mixture toward the user. In many cases a user simply does not have a strong enough tool, or one correctly configured for the job at hand Round edges of spoons do poorly for effectively moving the body of candy mixture around a work surface. Spatulas either melt or flex to much as the candy hardens.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out herein.

### SUMMARY OF THE DISCLOSURE

An embodiment may comprise a use of an apparatus that comprises a blade portion made of substantially rigid material. Said blade portion may have a first scraping edge and a handle attachment structure. The apparatus may further comprise a first mixing plane opposing a second mixing plane and a second scraping edge and a third scraping edge disposed between said handle attachment structure and said first scraping edge. There may also be a handle portion having a length three times greater than said second scraping edge for leverage, and wherein said handle portion is attached to said blade portion by a plurality of fasteners and fastened through said handle attachment structure. The use of the apparatus may include scraping said blade along a mixing surface so as to push a plurality of portions of a candy body in a plurality of directions so as to mix air into said candy body and cool said candy body. The use may further comprise testing said candy body to determine the consistency of the candy body.

An embodiment may further include using said apparatus to maintain a single candy body, or may include using said apparatus to divide a single candy body in to a plurality of candy bodies. Additionally, an embodiment may include scraping said first scraping edge along said mixing surface, and/or, a second scraping edge along said mixing surface. Consistent with the above, the use may further include scraping a third scraping edge along said mixing surface. The use of such an apparatus may further include adding a flavoring to said candy body and mixing in said flavoring with said apparatus.

An embodiment may be formulated into a system including an apparatus consistent with the above, a mixing surface, and additional candy making ingredients. In various embodiments the mixing surface maybe made of stone, metal, wood, plastic or other suitable material. The system may further include blade attachments that would aid the apparatus in being used with various materials. Such blade attachments may protect the blade and surface alike. The blade attachments may further include attachment structures for attaching to the blade or may be simply friction fit.

An embodiment may take the form of a kit wherein differing apparatuses may be included therein. For example, such a kit may comprise a large apparatus and a small apparatus, wherein the plurality of apparatuses may be used at differing portions of the candy making process.

An embodiment consistent with the disclosure may include a blade portion made of substantially ridged material, wherein the blade portion has a first, second and third scraping edge. The blade portion may further include a protrusion or structure for attaching and handle thereto. The blade portion may also include first and second mixing planes for mixing candy thereby and thereon. The handle portion may be sized so as to be at least three times the length of the blade portion in order to provide adequate leverage for a user. Additionally, the blade portion may be attached to said handle portion with a plurality of fasteners to resist relative rotation between the components during use. An embodiment may include a handle attachment structure that protrudes into said handle. An embodiment may include a first scraping edge cover, wherein said cover is made of a different material than said blade portion. An embodiment may include a cover made of rubber or another polymeric material. An embodiment may include a handle that is made of wood, and wherein the handle has a contour therein for increased usability. An embodiment may comprise a handle that is made out of metallic material or a plastic material. An embodiment may have a blade portion made out of plastic, wood or metal. An embodiment may comprise a blade portion having a flexible tip or flexible tip covers.

### BRIEF DESCRIPTION OF THE DRAWINGS

The features and advantages of the disclosure will become apparent from a consideration of the subsequent detailed description presented in connection with the accompanying drawings in which:

FIG. 1 is an illustration of an embodiment of the features of the disclosure and made in accordance with the teachings and principles of the disclosure;

FIG. 2 is an illustration of an embodiment of a candy making device made in accordance with the teachings and principles of the disclosure;

FIG. 3 is an illustration of an embodiment of a candy making apparatus made in accordance with the teachings and principles of the disclosure;

FIG. 4 is an illustration of the use of an embodiment of an apparatus for making candy in accordance with the disclosure;

FIG. 5 is an illustration of an embodiment of a candy making device made in accordance with the teachings and principles of the disclosure;

FIG. 6 is an illustration of an embodiment of a candy making device made in accordance with the teachings and principles of the disclosure;

FIG. 7 is an illustration of an embodiment of a candy making device made in accordance with the teachings and principles of the disclosure;

FIG. 8 is an illustration of an embodiment of a candy making device made in accordance with the teachings and principles of the disclosure; and

FIGS. 9a - 9f illustrate the use of a candy making apparatus made in accordance with the teachings and principles of the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the devices, systems, methods and processes for aerating and mixing a candy body are disclosed and described, it is to be understood that this disclosure is not limited to the particular embodiments, configurations, or process steps disclosed herein as such embodiments, configurations, or process steps may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

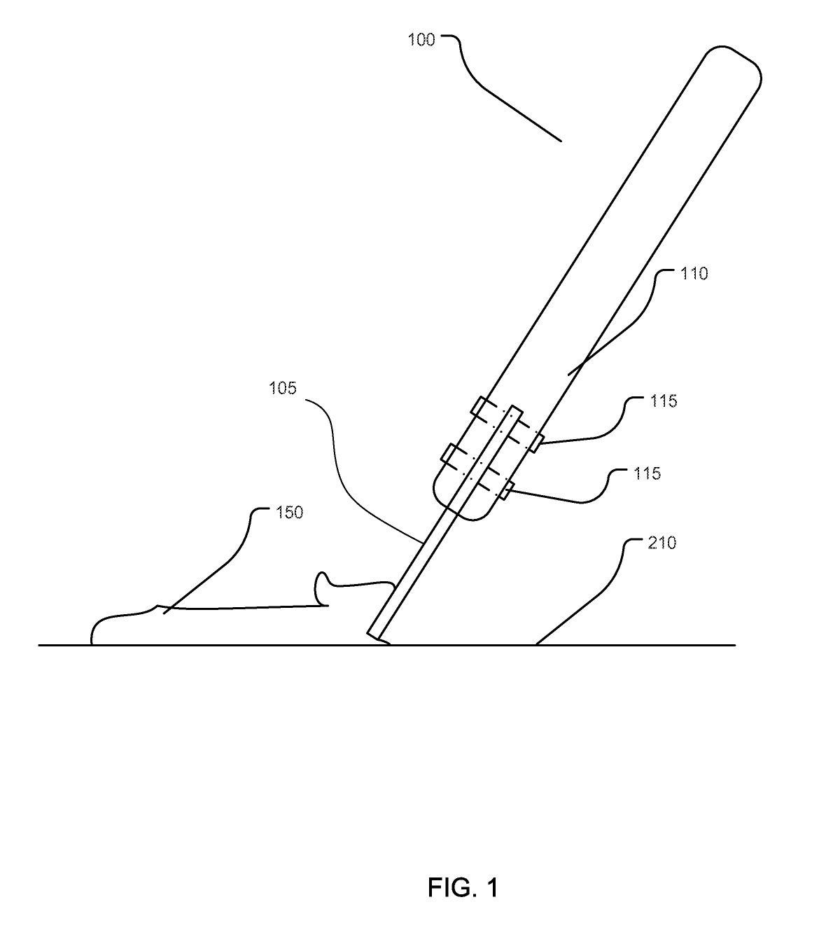

With reference primarily to FIG. 1, an embodiment of the features of the disclosure will be discussed generally. FIG. 1 illustrates a candy mixing apparatus 100 for use in making candy. The candy mixing apparatus 100 may comprise a blade portion 105 and a handle portion 110. The blade portion 105 may be made of substantially rigid material such as a metal, plastic, or wood. The blade portion 105 may be attached to the handle portion 110 with fasteners 115. The blade portion 105 may comprise additional structures that will be discussed in detail below.

As can be further seen in FIG. 1, the candy mixing apparatus 100 is interacting with a work surface 210 in order to manipulate and mix a body of candy mixture 150. The work surface 210 may be made of marble, granite, stone, metal, wood, plastic or a combination thereof. As can be seen in the figure, as the candy mixing apparatus 100 is moved into the body of candy mixture 150, the body of candy mixture 150 is manipulated from its resting state. Manipulating the candy mixture 150 may aid in the introduction of cooling air, coloring, flavorings or any manner of ingredients. An embodiment of the apparatus 100 may comprise a total length of said apparatus 100 that may be about 24.5 inches and may have a handle width of about 1 inch by about 1.5 inches. The embodiment may further comprise a paddle or blade portion 105 that may be about 4.5 inches in height by about 3.5 inches in width and may be made from metal or other sufficiently rigid material. The embodiment may range in total length from about 12 inches to about 24.5 inches. The embodiment may have a blade portion 105 that ranges from about 2 inches to about 4 inches in width and have a height that ranges from about 2 inches to about 5 inches. Embodiments of the handle portion 110 may range from about 1 inch by 1 inch to about 1 inch by 1.5 inches.

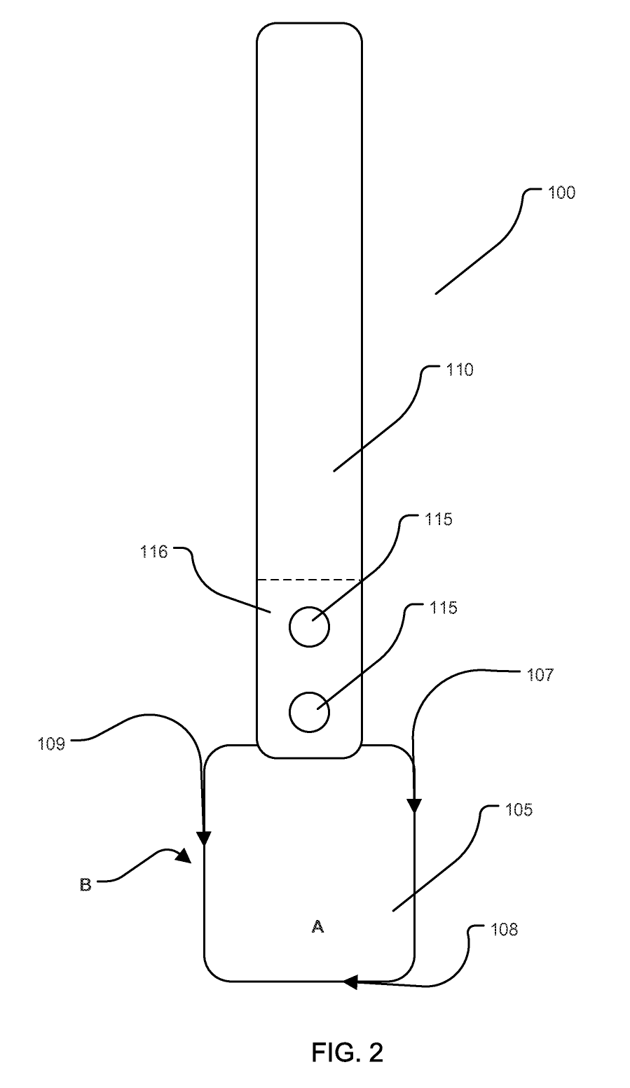

Referring now to FIG. 2, the blade portion 105 of the candy mixing apparatus 100 will be discussed in greater detail. As is illustrated in FIG. 2, the blade portion 105 may consist of three working or scraping edges 107, 108, 109, positioned at the edges of the blade portion 105. During use, a user may employ all of the edges in the candy making process. For example, when maximum leverage is needed, scraping edge 108 may be employed to take advantage of the maximum leverage of the handle portion 110. In other operations, side scraping edges 107 and 109 may be employed.

As further can be seen in FIG. 2, the blade portion 105 may be shorter than the handle portion 110. In some embodiments, the ratio of handle length to blade length could exceed 3:1, and may have a range of values of about 2:1 to 6:1. Additionally, a user may choose to “choke” down on the handle portion 110 for quicker movement, much like a baseball player chokes down on a baseball bat. It may be further noted that the location of fasteners 115, and type of fasteners 115 should be chosen with sufficient dimensions to handle the load placed thereon, such that the blade portion 105 does not move relative to the handle portion 110. The blade portion 105 may further have a protrusion or attachment structure 116 for attaching the blade portion 105 to the handle portion 110. It will be appreciated that the attachment structure 116 will mechanically interact with the handle portion 110 and fasteners 115.

Additionally, FIG. 2 illustrates two working planes, namely plane A and plane B, on the blade portion 105. The working planes A and B structurally separate the scraping edges 107, 108, 109, and operate in a manner to manipulate the candy mixture.

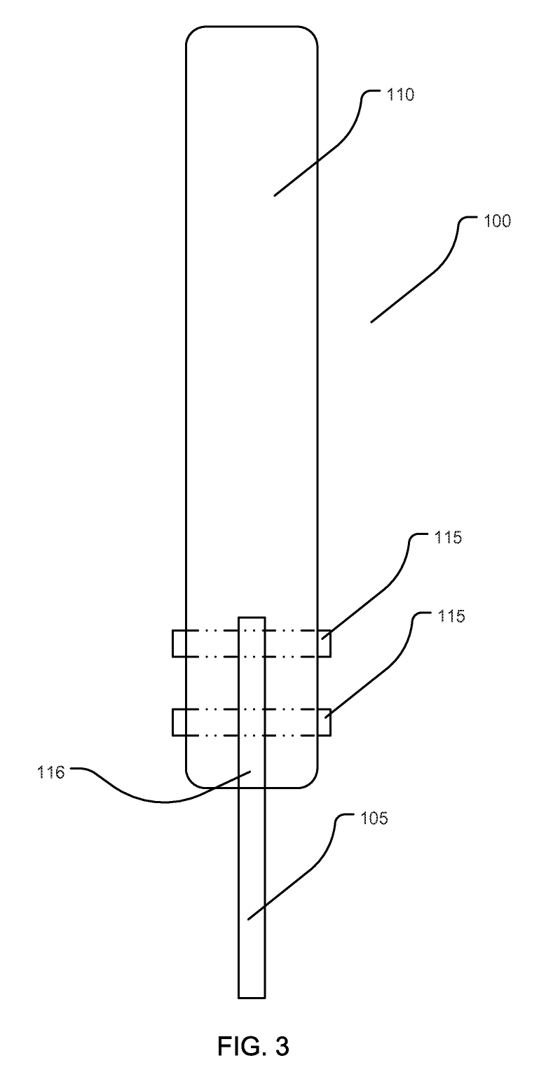

Referring now to FIG. 3, the handle portion 110 of the candy mixing apparatus 100 will be discussed. Illustrated in FIG. 3 is a side view of the candy mixing apparatus 100. It should be noted that the drawings are not intended to be to scale, but are rather intended to best illustrate the features of the disclosure. The handle portion 110 may be constructed of wood or other suitable material. The choice of wood that may be chosen as the handle portion may include a rustic or other finish or qualities to provide an heirloom for an aesthetically pleasing device. Wood may also be chosen for its properties, such as rigidity, gripability, and workability. Other materials may be used as well such as metal or plastics. As can be seen in the figure, fasteners 115 may span the complete width of the candy mixing apparatus 100.

Additional fastening means are contemplated and are intended to fall within the scope of this disclosure. For example, bands around the handle 110 and blade 105 portions may hold the two together. Additionally, a quality glue may be used the hold the components together, and the fasteners may be of any known in the art today, or those yet to be develops. And finally, the fasteners may be recessed in the material of the associated handle portion 110.

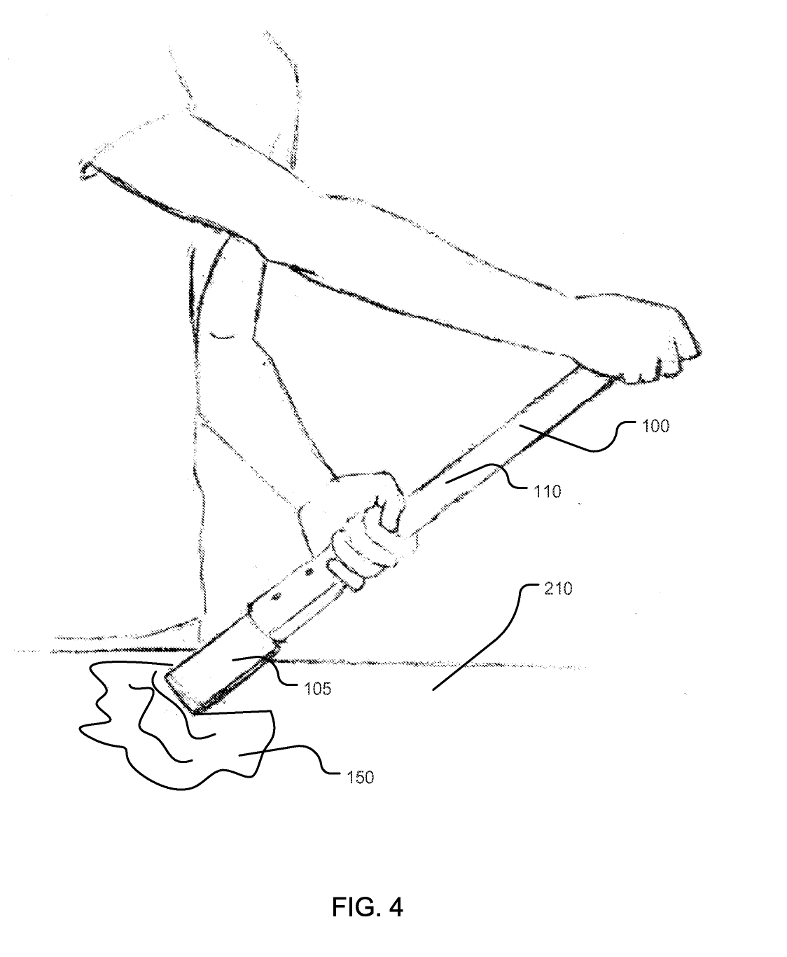

Illustrated in FIG. 4 is an embodiment of use for the candy mixing apparatus 100. As can be seen in the figure, a user may grasp the handle portion 110 comfortably and move the blade portion 105 into the body of candy mixture 150 on the work surface 210. As stated above, a user may choose to “choke” down on the handle portion 110 for quicker movement, much like a baseball player chokes down on a baseball bat.

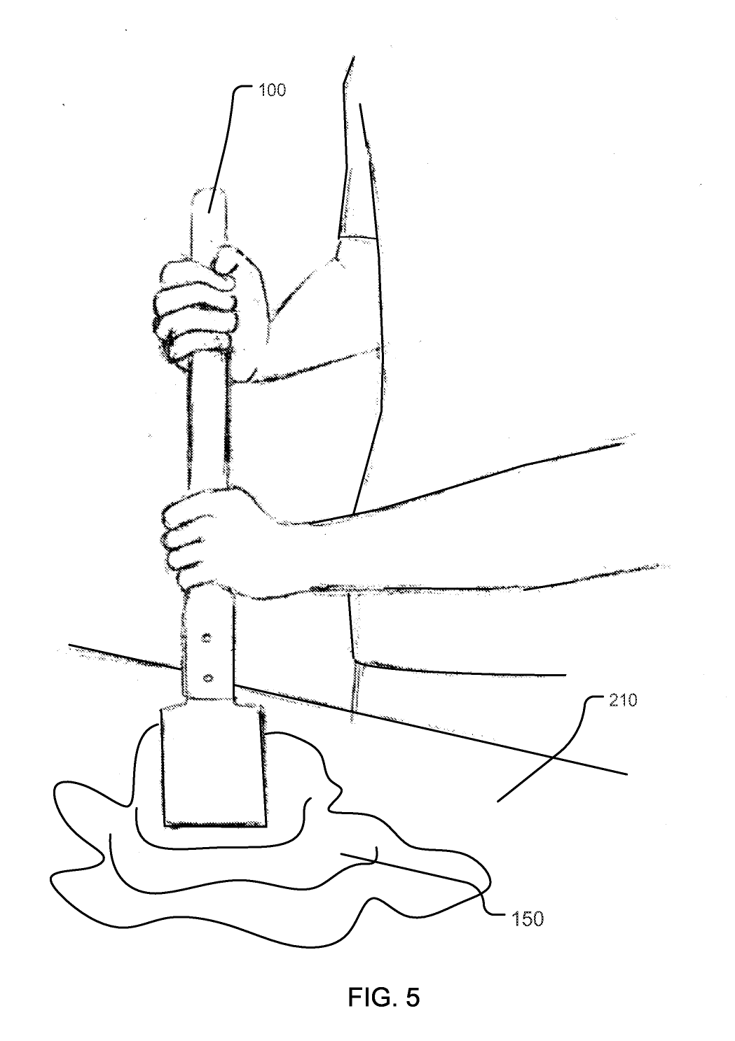

Referring now to FIG. 5, additional functionality of the apparatus 100 is shown from that of FIG. 4. One of the advantages of providing a handle 110 as described herein, may be that it is of such a size that the user may grip the handle in varying hand holds or positions as additional leverage is needed or as fatigue sets in. As can be seen in FIG. 5, the user has reversed the grip previously illustrated in FIG. 4. The user has done this while doing a similar scraping action, but with the result of using a different set of muscles, which may aid in reducing fatigue. In FIG. 4, the majority of the effort is being used to pull the tool or apparatus 100 toward the user. In contrast, the action of FIG. 5 is to push the tool or apparatus 100 away from the user. Such repeated motions with the disclosed candy mixing apparatus 100 can be used to manipulate the making of candy.

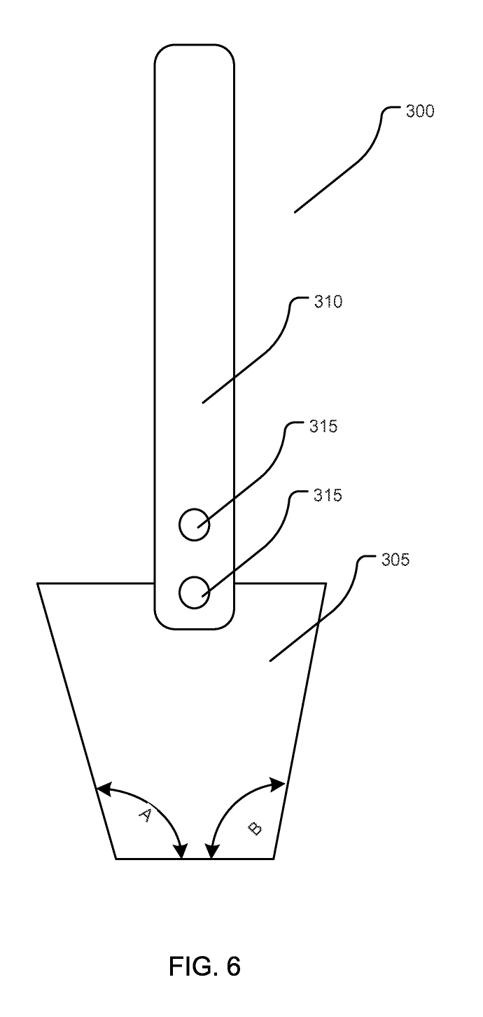

Referring now to FIG. 6, an embodiment of a candy mixing apparatus 300 is shown as having a blade portion 305 configuration wherein angles A and B are not ninety (90) degree angles. By changing the angles between the scraping edges, e.g., between the first scraping edge and the second and third scraping edge, of the blade portion 305 different user positions can be enabled. For example, where angle A is greater than ninety degrees, a user will be able to keep his/her hands further away from the material being worked. A flared blade portion 305 configuration provides differing scraping and leverage angles for various uses. It is within the scope of this disclosure to contemplate embodiments having angles greater than 90 degrees and less than 90 degrees.

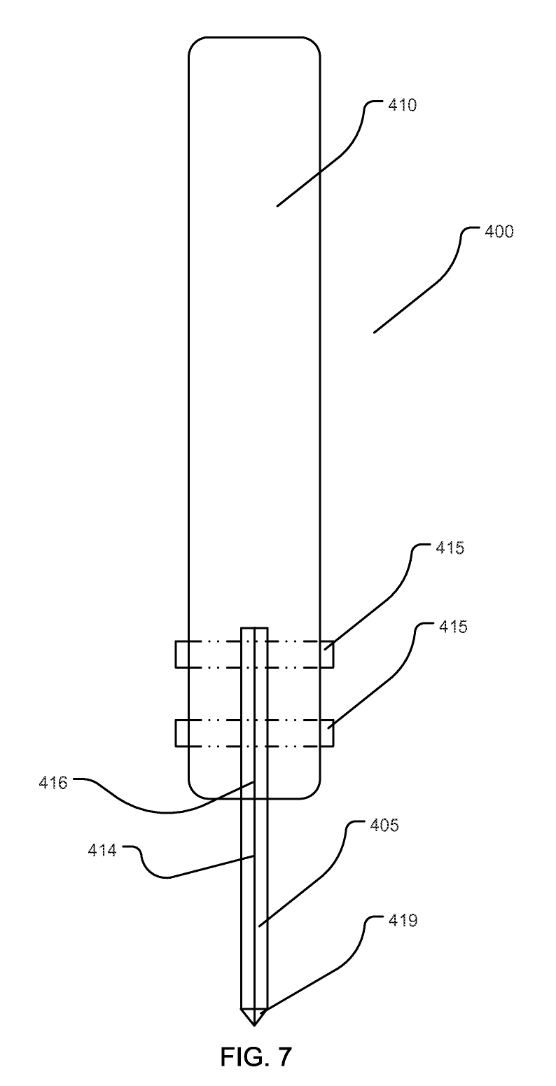

Illustrated in FIG. 7 is a side view of an embodiment of a candy mixing apparatus 400. It should be noted that the drawings are not intended to be to scale, but are rather intended to best illustrate the features of the disclosure. The handle portion 410 may be constructed of wood or other suitable material. A choice of wood may be made for its rustic or heirloom qualities for an aesthetically pleasing device. Wood may also be chosen for its properties, such as rigidity, gripability, and workability. Other materials maybe used as well such as metal or plastics. As can be seen in the figure, fasteners 415 may span the complete width of the candy mixing apparatus 400.

Additional fastening means are contemplated and are intended to fall within the scope of this disclosure. For example, bands around the handle 410 and blade 405 portions may hold the two together. Additionally, a quality glue may be used the hold the components together, and the fasteners may be of any known in the art today, or those yet to be developed. And finally, the fasteners may be recessed in the material of the associated handle 410.

As is illustrated in FIG. 7, the blade portion 405 may consist of three working or scraping edges positioned at the edges of the blade portion 405. During use a user may employ all of the edges in the candy making process. For example, when maximum leverage is needed, the front scraping edge may be employed to take advantage of all of the leverage of the handle portion 410. In other operations the side scraping edges may be employed.

As further can be seen in FIG. 7 the blade portion 405 may be shorter than the handle portion 410. In some embodiments the ratio of handle to blade length could exceed 3:1, and may have a range of values of about 2:1 to about 6:1. Additionally, a user may choose to “choke” down on the handle portion 410 for quicker movement, much like a baseball player chokes down on a baseball bat. It may be further noted that the location of fasteners 415, and type of fasteners 415 should be chosen with sufficient dimensions to handle the load placed thereon, such that the blade portion 405 does not move relative to the handle portion 410. The blade portion 405 may further have a protrusion or attachment structure 416 for attaching the blade portion 405 to the handle portion 410. It will be appreciated that the attachment structure 416 will mechanically interact with the handle portion 410 and fasteners 415.

Additionally illustrated in the FIG. 7 are beveled or tapered profiles 419 for the edges of the blade 405. The profile of the scraping edges may comprise a simple bevel, or may comprise a rounder profile. Such shaping of the blade edge may increase the scraping ability of the blade portion 405 as to various work surfaces. For example, a bevel profile may work well with a work surface such as stone, while another profile shape would work better with metal surfaces, while yet another would work better with wood or plastic surfaces.

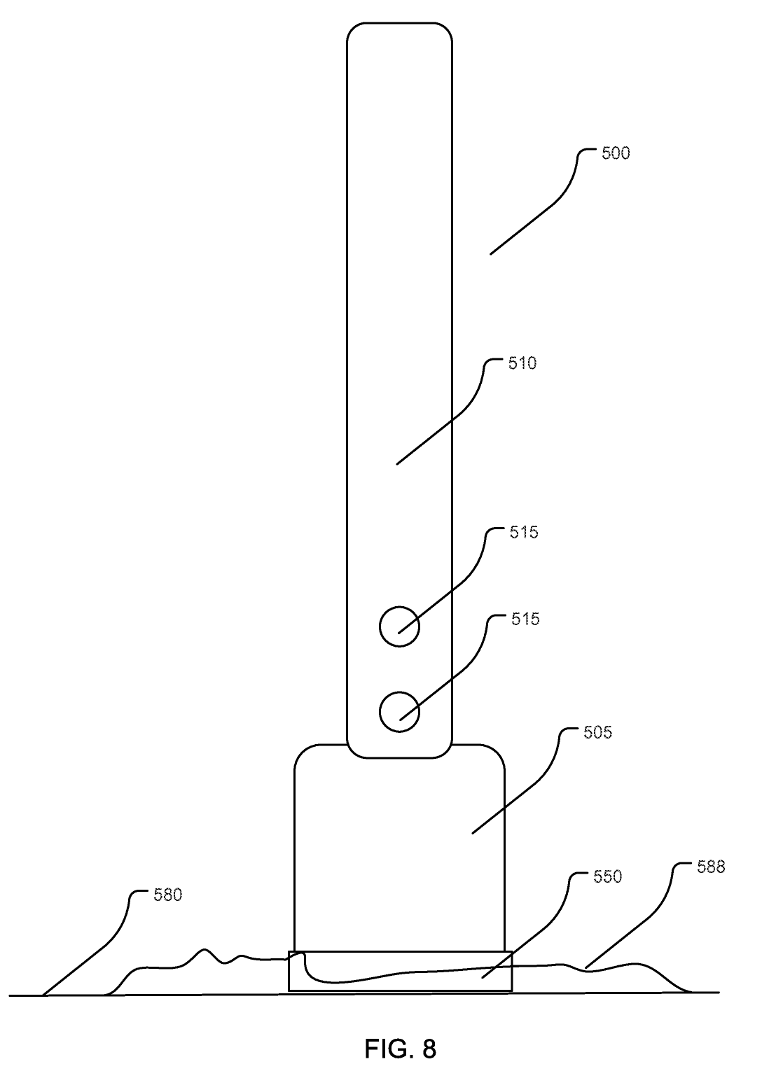

Illustrated in FIG. 8 is a front view of an embodiment of a candy mixing apparatus 500. The candy mixing apparatus 500 may comprise a blade portion 505 and a handle portion 510. The blade portion 505 may be made of substantially rigid material such as a metal, plastic, or wood. The blade portion 505 may be attached to the handle portion 510 with fasteners 515. The blade portion 505 may comprise additional structures that will be discussed in detail below.

As can be further seen in FIG. 8, the candy mixing apparatus 500 is interacting with a work surface 580 in order to manipulate and mix a body of candy mixture 588. The work surface 580 may be made of marble, granite, stone, metal, wood, and plastic. As can be seen in the figure, as the candy mixing apparatus 500 is moved into the body of candy mixture 588, the body of candy mixture 588 is manipulated from its resting state. Manipulating the candy mixture 588 may aid in the introduction of cooling air, coloring, flavorings or any manner of ingredients.

As stated above, various materials can be used for a work surface. Depending upon the work surface chosen, and to aid in the versatility of the candy mixing apparatus 500, a cover 550 may be placed over an edge on the blade portion 505 for protecting the work surfaces and/or the blade edges. Such a cover may be attached to the blade portion 505 via a friction fit or may be attached with other attachment structures. The cover 550 may be made of plastic, nylon, rubber, wood, or any other material suitable for use with various working surfaces made from various materials. The cover 550 may provide a squeegee effect to aid in the mixing process. A plurality of covers 550 may be provided and used to increase the versatility of the candy mixing apparatus 500. A kit may comprise a candy mixing apparatus 500 and may comprise a cover 550. A kit may further comprise a plurality of covers 550 and another kit may comprise a plurality of candy mixing apparatuses 500.

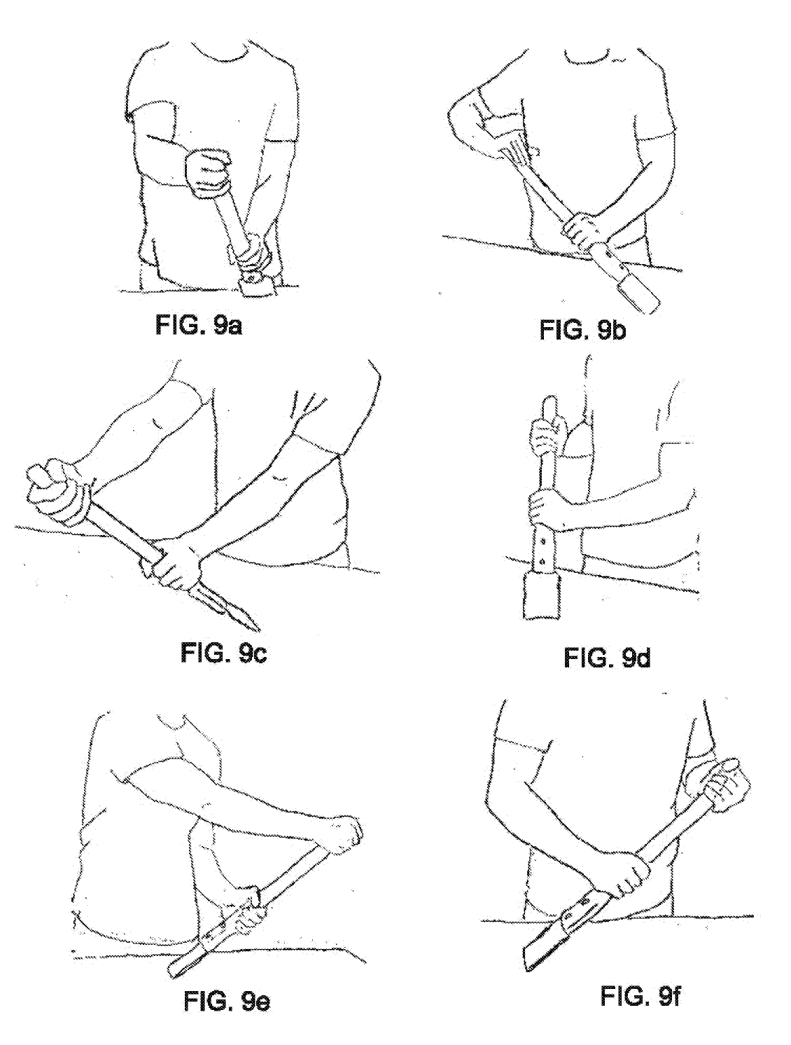

Illustrated in FIGS. 9a - 9f is a method of using an apparatus for mixing candy consistent with the disclosure herein. As can be seen in FIG. 9a, by a user placing one hand at the top of the handle, and placing the other hand at the bottom of the handle near the blade, a user can control the candy mixing apparatus with ease. As shown in FIG. 9a a user can pull the blade portion toward themself, or in a reverse motion push material away from themself.

As shown in FIG. 9b, a user can use the palm of his/her upper hand to drive the blade portion to thereby scrape along a work surface. FIG. 9c illustrates a use of the candy mixing apparatus wherein a user can pull the blade portion toward themself, or in a reverse motion push material away from themself. FIG. 9d illustrates that a user can use the candy mixing apparatus laterally off to the side of the body. FIGS. 9e - 9f illustrate that the candy mixing apparatus can be used to scrape latterly across a work surface as a user progresses from the position of 9e to the position of 9f.

During any of the above uses coloring or flavoring may be added to the body of candy along with other ingredients. By doing the steps illustrated and described above, a body of candy can be worked into the desired finished product.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method for modifying a body of candy comprising:
manipulating a body of malleable candy with an apparatus that comprises:
a blade portion made of substantially rigid material comprising:
a first scraping edge;
a handle attachment structure;
a first mixing plane opposing a second mixing plane;
a second scraping edge and a third scraping edge disposed between said handle attachment structure and said first scraping edge;
a handle portion having a length at least three times greater than said second scraping edge; and
wherein said handle portion is attached to said blade portion by a plurality of fasteners and fastened through said handle attachment structure;
scraping said blade along a mixing surface so as to push a plurality of portions of said body of candy in a plurality of directions so as to mix air into said body of candy and cool said body of candy;
testing said body of candy to determine consistency of said body of candy.

2. The method of claim 1 further comprising using said apparatus to maintain a single candy body.

3. The method of claim 1 further comprising using said apparatus to divide a single candy body in to a plurality of candy bodies.

4. The method of claim 1 further comprising scraping said first scraping edge along said mixing surface.

5. The method of claim 1 further comprising scraping said second scraping edge along said mixing surface.

6. The method of claim 1 further comprising scraping said third scraping edge along said mixing surface.

7. The method of claim 1 further comprising adding a flavoring to said candy body and mixing in said flavoring with said apparatus.

8. The system for making candy comprising:
an apparatus for making candy comprising:
a blade portion made of substantially ridged material comprising:
a first scraping edge;
a handle attachment structure;
a first mixing plane opposing a second mixing plane;
a second scraping edge and a third scraping edge disposed between said handle attachment structure and said first scraping edge;
a handle portion having a length at least three times greater than said second scraping edge;
wherein said handle portion is attached to said blade portion by a plurality of fasteners and fastened through said handle attachment structure; and
a mixing surface device having a flat mixing surface.

9. The system of claim 8, wherein said mixing surface comprises stone.

10. The system of claim 8, wherein said mixing surface comprises metal.

11. The system of claim 8, wherein said mixing surface comprises wood.

12. The system of claim 8, wherein said apparatus further comprises a cover for said blade.

13. The system of claim 8, wherein said apparatus further comprises a plurality of covers for said blade.

14. The kit for making candy comprising:
a first apparatus for making candy comprising:
a blade portion made of substantially ridged material comprising:
a first scraping edge;
a handle attachment structure;
a first mixing plane opposing a second mixing plane;
a second scraping edge and a third scraping edge disposed between said handle attachment structure and said first scraping edge;
a handle portion having a length at least three times greater than said second scraping edge;
wherein said handle portion is attached to said blade portion by a plurality of fasteners and fastened through said handle attachment structure;
a second apparatus for making candy comprising:
a blade portion made of substantially ridged material comprising:
a first scraping edge;
a handle attachment structure;
a first mixing plane opposing a second mixing plane;
a second scraping edge and a third scraping edge disposed between said handle attachment structure and said first scraping edge;
a handle portion having a length three times greater than said second scraping edge;
wherein said handle portion is attached to said blade portion by a plurality of fasteners and fastened through said handle attachment structure; and
wherein said second apparatus is smaller than said first apparatus.

15. The kit of claim 14 further comprising a mixing surface device.

16. An apparatus for making candy comprising:
a blade portion made of substantially ridged material comprising:
a first scraping edge;
a handle attachment structure;
a first mixing plane opposing a second mixing plane;
a second scraping edge and a third scraping edge disposed between said handle attachment structure and said first scraping edge;
a handle portion having a length at least three times greater than said second scraping edge; and
wherein said handle portion is attached to said blade portion by a plurality of fasteners and fastened through said handle attachment structure.

17. The apparatus for making candy of claim 16, wherein said handle attachment structure protrudes in to said handle.

18. The apparatus for making candy of claim 16, further comprising a first edge cover.

19. The apparatus for making candy of claim 18 wherein said cover is made of a different material than said blade portion.

20. The apparatus for making candy of claim 19 wherein said cover is made of a material comprising rubber.

21. The apparatus for making candy of claim 19 wherein said cover is made of a material comprising a man made polymer.

22. The apparatus for making candy of claim 16 wherein said handle portion is made of wood.

23. The apparatus for making candy of claim 16 wherein said handle portion comprises a comfort contour.

24. The apparatus for making candy of claim 16 wherein said handle portion is made of metal.

25. The apparatus for making candy of claim 16 wherein said handle portion is made of plastic.

26. The apparatus for making candy of claim 16 wherein said blade portion is made of metal.

27. The apparatus for making candy of claim 16 wherein said blade portion is made of plastic.

28. The apparatus for making candy of claim 16 wherein said blade portion is made of wood.
